(19) United States
(12) Patent Application Publication
(10) Pub. No.: US 2003/0112925 A1
(43) Pub. Date: Jun. 19, 2003

(54) X-ray cassette holding means for variably adjusting angles and positions

(76) Inventor: Shyh-Jen Wang, Taipei (TW)

Correspondence Address: Shyh-Jen Wang, P. O. BOX 55-846, Taipei, 104, TW

(21) Appl. No.: 10/023,602

(22) Filed: Dec. 13, 2001

(51) Int. Cl. G03B 42/04

(52) U.S. Cl. 378/182

(57) ABSTRACT

A X-ray cassette holding device includes a supporting frame having a vertical column telescopically mounted on a stand and a horizontal shaft secured to the vertical column; an adjustable fastening device slidably and rotatably engaged on the horizontal shaft; and a holding bracket connected to the adjustable fastening device for fastening a X-ray cassette on the bracket; whereby upon a horizontal displacement or angular rotation of the fastening device on (or about) the horizontal shaft, the fastening device can be operated to be firmly fastened on the shaft of the supporting frame to obtain an optimum position or angle of the X-ray cassette adapted to be aimed at by a X-ray source through a patient's body portion.

### BACKGROUND OF THE INVENTION

A conventional platform for X-ray examination for positioning a patient's knee for X-ray evaluation was disclosed in U.S. Pat. No. 4,700,373 by Edward H. Miller. However, such a prior art does not provide an ergonomic adjusting mechanism for variably adjusting the positioning of the X-ray cassette on the platform (10). For instance, there are only four positions (FIGS. 4-7 of the prior art) for adjusting the height positions of the cassette (C) on the posts (18) on the platform (10) by rotating the pair of blocks (22) pivotally mounted on the posts (18).

Meanwhile, it is lacking of an angle-adjusting device for adjusting a rotating angle of the X-ray cassette about a horizontal shaft.

So, it can not be manipulated smoothly ergonomically for adjusting the positions and angles of the X-ray cassette on such a conventional platform.

The present inventor has found the drawbacks of the conventional X-ray cassette holding devices and invented the present X-ray cassette holding means as variably adjusted.

### SUMMARY OF THE INVENTION

The object of the present invention is to provide a X-ray cassette holding device including a supporting frame having a vertical column telescopically mounted on a stand and a horizontal shaft secured to the vertical column; an adjustable fastening device slidably and rotatably engaged on the horizontal shaft; and a holding bracket connected to the adjustable fastening device for fastening a X-ray cassette on the bracket; whereby upon a horizontal displacement or angular rotation of the fastening device on (or about) the horizontal shaft, the fastening device can be operated to be firmly fastened on the shaft of the supporting frame to obtain an optimum position or angle of the X-ray cassette adapted to be aimed at by a X-ray source through a patient's body portion.

### BRIEF DESCRIPTION OF THE DRAWINGS

FIG. 1 is an illustration showing an application of the present invention for use on a X-ray examination table.

FIG. 2 is an exploded view of the elements of the present invention.

FIG. 3 is a partial sectional drawing of the adjustable fastening means of the present invention.

FIG. 4 is a sectional drawing of another preferred embodiment of the adjustable fastening means of the present invention.

FIG. 5 shows another fastening device.

FIG. 6 shows still another fastening device.

### DETAILED DESCRIPTION

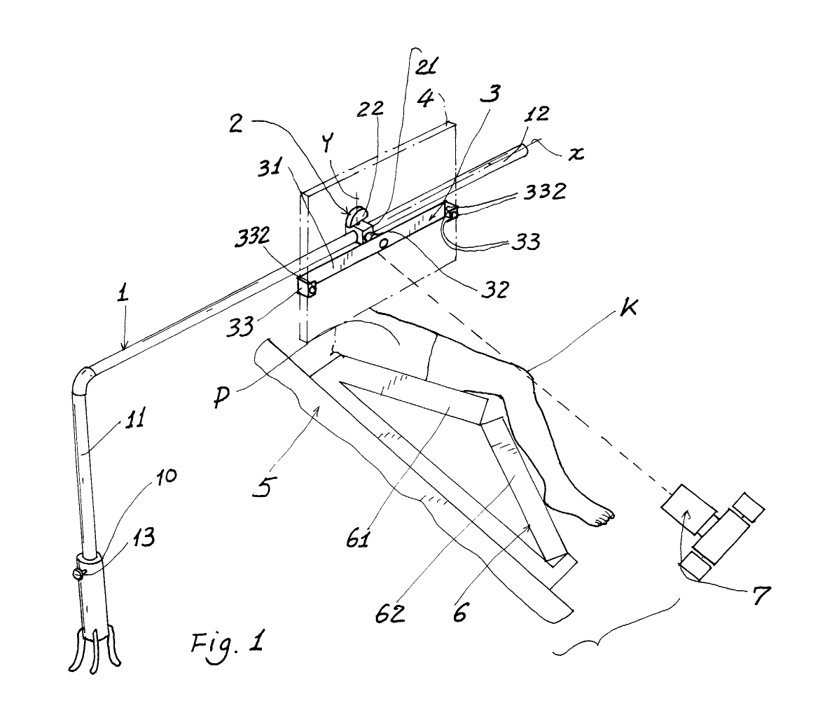

The present invention relates to a X-ray cassette holding means for variably adjusting its positions and angles. Even though the drawing figure (FIG. 1) illustrates an application for obtaining X-ray view of a patient's flexed knee joint, the present invention is however not limited to the X-ray view of the flexed knee. Other body portions can be viewed in accordance with the present invention.

As shown in FIGS. 1-3, the holding means of the present invention comprises: a supporting frame 1 including a vertical column 11 and a horizontal shaft 12 secured (or perpendicularly secured) to the vertical column 11; an adjustable fastening means 2 mounted on the shaft 12; and a holding bracket 3 connected to the fastening means 2.

The adjustable fastening means 2 includes: a holding base 21 capable of sliding or rotating on the horizontal shaft 12; a driving bolt 22 rotatably engageable with the holding base 21; and a thrusting member 23 rotatably coupled with the driving bolt 22 and reciprocatively held in the holding base 21; whereby upon rotating the driving bolt 22, the thrusting member 23 will be driven to interfere in the surface of the shaft 12 for firmly fastening the shaft 12 with the holding base 21.

The shaft 12 may be referred to a bar, beam, tubular cylinder, or any other rod-like fixture, preferably formed as cylindrical shape, but not limited in the present invention.

The vertical column 11 may be telescopically mounted on a stand 10 and locked by a locking knob 13 after obtaining a suitable adjusted height of the column 11 and the shaft 12 having the fastening means 2 loaded thereon. The stand 10 may also be eliminated and the frame 1 may be directly secured on an examination table, a bed or any other objects.

The holding base 21 includes: a shaft hole 211 longitudinally formed in or through the holding base capable of sliding or rotating with the shaft 12 about a longitudinal axis X which exists at a longitudinal center of the shaft 12; a sleeve hole 210 transversely formed in the holding base 21 about a latitudinal axis Y projectively perpendicular to the longitudinal axis X; a screw hole 212 formed in the holding base 21 and coaxially communicated with the sleeve hole 210 about the latitudinal axis Y; and an adapter 20 formed on the holding base 21 to be coupled or connected with the holding bracket 3.

The driving bolt 22 includes: a bolt shank portion 220, a screw portion 221 having male threads formed thereon and formed on a distal end of the shank portion 220 to be engageable with the screw hole 212 formed in the holding base 21, a handle (or knob) 222 formed on a proximal end of the shank portion 220, and a neck portion 223 annularly recessed in the shank portion 220 adjacent to the handle portion 222.

The thrusting member 23 includes: a sleeve 230 capable of sliding in the sleeve hole 210 formed in the holding base 21, a bolt hole 231 longitudinally formed through the sleeve 230 and rotatably engageable with the shank portion 220 of the driving bolt 22, a screw 232 rotatably formed in a screw hole 232a transversely formed through the sleeve 230 and engageable with the neck portion 223 of the driving bolt 22 for rotatably coupling the driving bolt 22 with the thrusting member 23, an arcuate recess 233 formed in a side surface of the sleeve 230 and operatively engaged with a cylindrical surface of the shaft 12, an elongate slot 234 formed in the sleeve 230 parallel to the latitudinal axis Y, and a limiting screw 235 secured in the holding base 21 and slidably engageable with the elongate slot 234 for preventing an axial rotation of the sleeve 230 about the latitudinal axis Y, and to ensure a snug engagement of the arcuate recess 233 with the shaft 12.

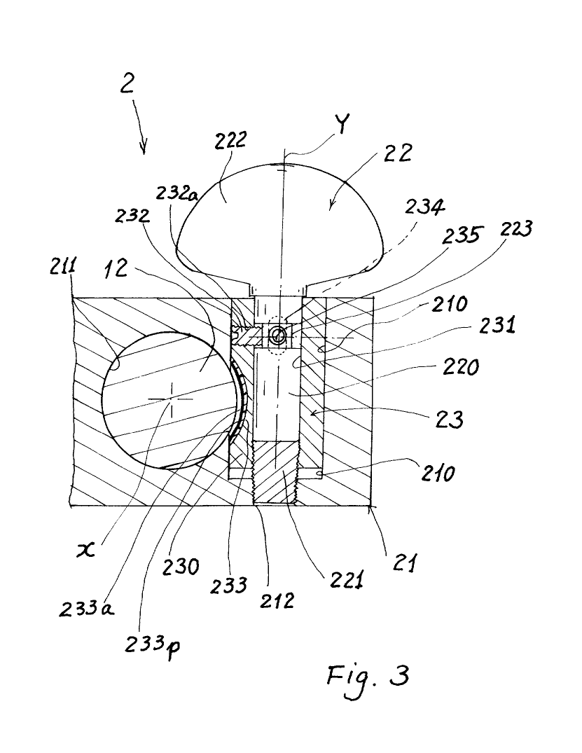

An aperture 233a is formed between the arcuate recess 233 and the shaft 12 (FIG. 3) to render a “stroke” during fastening or unlocking of the adjusting means 2 with or from the shaft 12. For preventing a free rotation of the shaft 12 from the recess 233, a packing member or layer 233p (made of rubber or other packing materials) may be coated or formed on the surface of the arcuate recess 233 (FIG. 3).

When it is intended to fasten the fastening means 2 on the shaft 12 after a horizontal displacement on the shaft 12 or a rotation about the axis X of the shaft 12, the driving bolt 22 is rotated about the axis Y to protrude inwardly in the sleeve hole 210 and the screw hole 212 to simultaneously drive the thrusting member 3 inwardly to allow the arcuate recess 233 to interfere in the cylindrical surface of the shaft 12, thereby firmly fastening the adjustable fastening means 2 on the horizontal shaft 12.

The holding bracket 3 includes: an elongate beam 31 having a connector 32 which may be a female socket formed on a rear middle portion of the elongate beam 31 to be coupled or connected with the adapter 20 (which may be a male plug) of the adjustable fastening means 2 already locked on the shaft 12 of the supporting frame 1; and a pair of U-shaped portions 33 disposed on opposite ends of the beam 3 each formed with a knob hole 331 to be engaged with a fastening knob 332, whereby upon insertion of a X-ray cassette into the two U-shaped portions 33 and upon locking of the two fastening knobs 332 in the two knob holes 331, the X-ray cassette 4 will be stably mounted on the holding bracket 3 (FIG. 1).

Naturally, the X-ray cassette 4 can also be inserted into the two U-shaped portions 33 and then leaned on the patient's body portion (such as the legs), regardless of the fastening knobs 332.

When using the present invention, the patient P lays on the examination table 5 in a supine position to let his (or her) upper and lower legs to be supported on a positioning platform 6 with two angle-adjusting supports 61, 62 for aligning the patient's flexed knee K with the X-ray cassette 4 and the X-ray source or tube 7 in order to obtain X-ray view of the patient's femoral-patella joint as shown in FIG. 1. For loosening, the knob 222 is rotated in a reverse direction to separate the thrusting member 23 from the shaft 12.

The present invention, especially as illustrated in FIG. 1, can be operated more ergonomically than the prior art with the following advantages:

1. The X-ray cassette 4 held on the bracket 3 and the fastening means 2 can be angularly adjusted about the shaft 12 (the axis X) or horizontally adjusted on the shaft 12 for variably adjusting the angles and positions of the X-ray cassette for obtaining a satisfactory qualified X-ray view helpful for better evaluating the patient's body portions.

2. The cassette 4 can be free adjusted for its heights in so many ways; either by telescopically adjusting the heights of the column 11 above the stand 10; or by upwardly or downwardly moving along the two U-shaped portions 33 on the bracket 3, besides the adjustment of the examination table.

3. The adjustment can be manipulated more easily ergonomically by merely rotating the knobs 222, 332, 13 for an efficient and comfortable service for the patients.

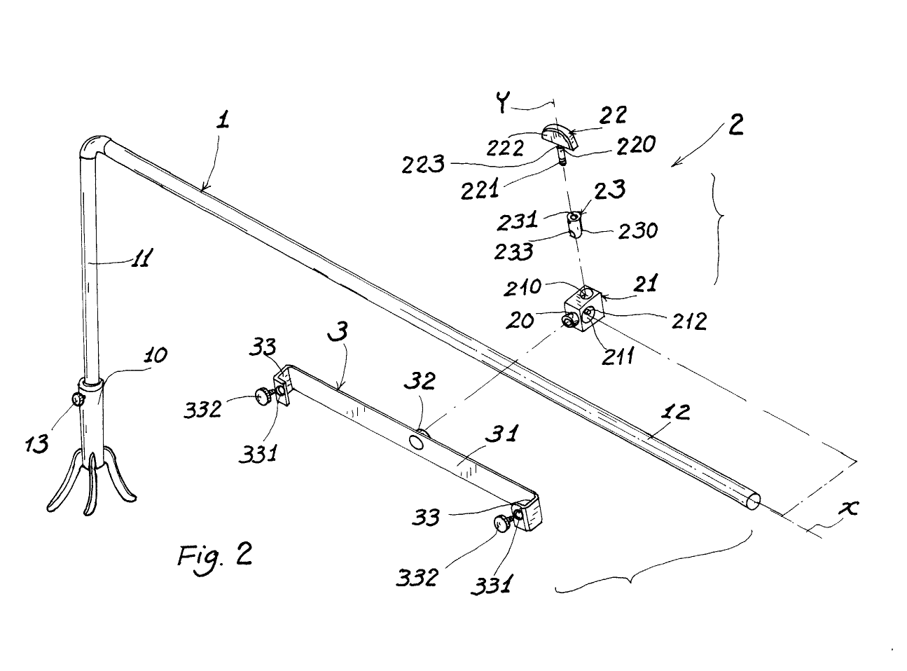

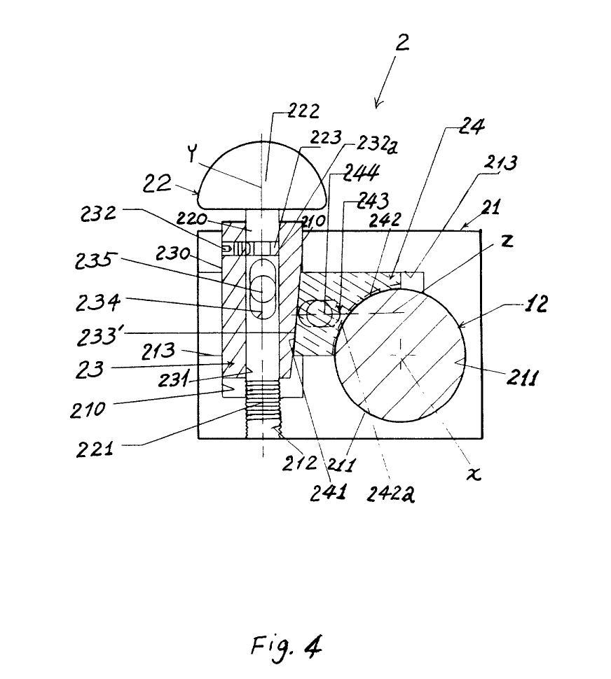

Another preferred embodiment of the adjustable fastening means 2 is shown in FIG. 4. The structure and mechanism is similar to that as shown in FIGS. 2, 3, except that a follower block 24 is added in the fastening means 2 and the sleeve member 23 is modified.

As shown in FIG. 4, the adjustable fastening means 2 of the present invention comprises: a holding base 21 capable of sliding or rotating on the shaft 12; a driving bolt 22 rotatably engageable with the holding base 21; a thrusting member 23 rotatably coupled with the driving bolt 22 and reciprocatively held in the holding base 21; and a follower block 24 tangentially engageable with the thrusting member 23 and reciprocatively moving in a block slot 213 about a slot axis Z formed in the holding base 21; whereby upon rotating the driving bolt 22, the thrusting member 23 will be inwardly driven simultaneously to thrust the follower block 4, then to interfere in the surface of the shaft 12 for firmly fastening the shaft 12 with the holding base 21 of the fastening means 2.

The follower block 24 includes: a follower wedge face 241 formed on a first end portion of the follower block 24 to be tangentially engageable with a driving wedge face 233′ of the thrusting member 23, a recess portion 242 recessed in a second end portion of the follower block 24 opposite to the follower wedge face 241 in order to interfere in (or to interferentially hold) the shaft 12, a screw slot 243 formed in the follower block 24 parallel to the slot axis Z in the block slot 213 in the holding base 21, and a stopping screw 244 secured in the holding base 21 and slidably engageable with the screw slot 243 for preventing an axial rotation of the follower block 24 about the slot axis Z.

The recess portion 242 may be formed as an arcuate shape and (or) coated with a packing layer 242a, which is made of rubber or elastomer materials, on the recess portion 242.

When fastening the shaft 12 with the fastening means 2 of the present invention by passing the shaft 12 in the hole 211 of the holding base 21, the driving bolt 22 is rotated about the axis Y to protrude inwardly in the hole 210 and screw hole 212 to simultaneously move the thrusting member 23 inwardly, whereby the follower wedge face 241 of the follower block 24 will be thrusted by the driving wedge face 233′ of the thrusting member 23 to push the follower block 24 towards the shaft 12, then the recess portion 242 of the follower block 24 is interfered in the cylindrical surface of the shaft 12, thereby firmly fastening the shaft 12 with the holding base 21. For loosening or separating the shaft from the base, the driving bolt 22 is rotated in a reverse direction to retract the block 24 from the shaft 12.

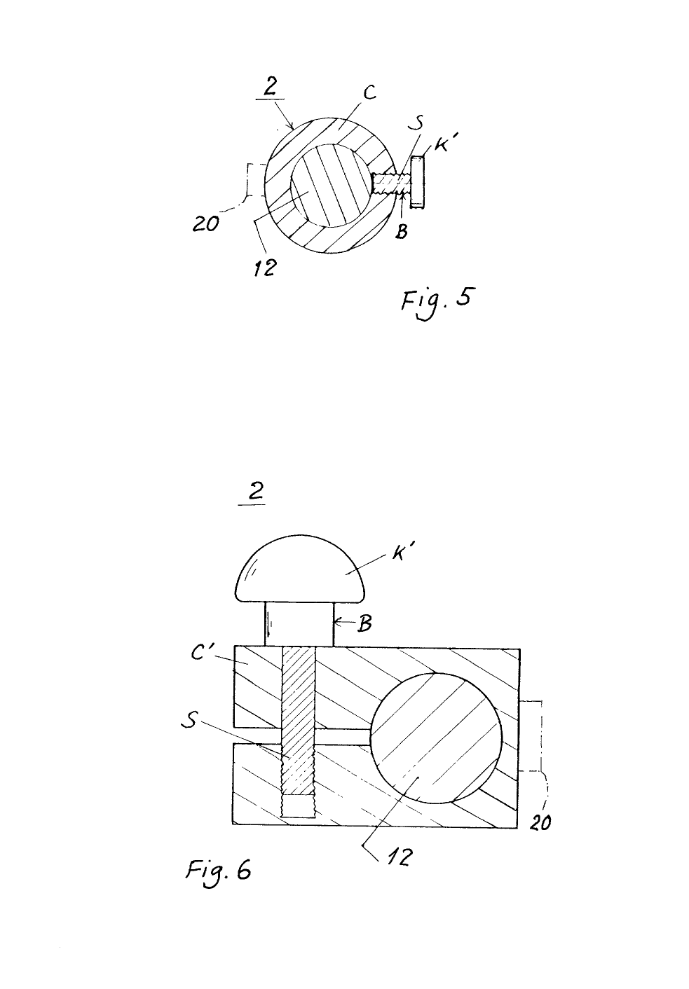

Another preferred embodiment of the adjustable fastening means 2 can be a bolt-pressing or bolt-clamping fastening device. The fastening means as shown in FIG. 5 includes: a collar C capable of sliding or rotating on the horizontal shaft 12, a driving bolt B having a screw portion S engaged with the collar to compress the shaft 12 upon rotation of knob K′ formed on an outer end of the bolt B, and the adapter 20 for connecting the holding bracket 3.

Still another fastening means 2 as shown in FIG. 6 includes a clamp C′ for fastening the horizontal shaft 12 upon driving of the knob K′ of a driving bolt B having a screw portion S coupling the clamp C′ to hold the shaft 12. An adapter 20 is formed on the clamp C′ for connecting the holding bracket 3.

The present invention may be modified without departing from the spirit and scope of the present invention.

I claim:

1. A X-ray cassette holding means comprising:
a supporting frame including a shaft secured to a column telescopically mounted on an object;
an adjustable fastening means slidably engaged with and rotatably mounted on said shaft of said supporting frame for adjusting a position and an angle of the fastening means on said shaft; and
a holding bracket connected with said fastening means for holding a X-ray cassette on said bracket.

2. A X-ray cassette holding means according to claim 1, wherein said supporting frame includes a vertical column telescopically mounted on an object selected from a stand and an examination table; and a horizontal shaft perpendicularly secured to said vertical column for mounting said fastening means on said shaft.

3. A X-ray cassette holding means according to claim 1, wherein said adjustable fastening means includes: a holding base capable of sliding or rotating on the shaft; a driving bolt rotatably engageable with the holding base; and a thrusting member rotatably coupled with the driving bolt and reciprocatively held in the holding base; whereby upon rotating the driving bolt, the thrusting member will be driven to interfere in a cylindrical surface of the shaft for firmly fastening the shaft with the holding base.

4. A X-ray cassette holding means according to claim 2, wherein said vertical column is telescopically mounted on said stand and locked by a locking knob after obtaining a suitable height of the column and the shaft having the fastening means loaded thereon.

5. A X-ray cassette holding means according to claim 3, wherein said holding base includes: a shaft hole longitudinally formed in the holding base capable of sliding or rotating with the shaft about a longitudinal axis which exists at a longitudinal center of the shaft; a sleeve hole transversely formed in the holding base about a latitudinal axis projectively perpendicular to the longitudinal axis; a screw hole formed in the holding base and coaxially communicated with the sleeve hole about the latitudinal axis; and an adapter formed on the holding base to be connected with a holding bracket.

6. A X-ray cassette holding means according to claim 5, wherein said driving bolt includes: a bolt shank portion, a screw portion having male threads formed thereon and formed on a distal end of the shank portion to be engageable with the screw hole formed in the holding base engaged with the shaft, a handle formed on a proximal end of the shank portion, and a neck portion annularly recessed in the shank portion adjacent to the handle portion.

7. A X-ray cassette holding means according to claim 6, wherein said thrusting member includes: a sleeve capable of sliding in a sleeve hole formed in the holding base, a bolt hole longitudinally formed through the sleeve and rotatably engageable with the shank portion of the driving bolt, a screw rotatably formed in a screw hole transversely formed through the sleeve and engageable with the neck portion of the driving bolt for rotatably coupling the driving bolt with the thrusting member, an arcuate recess formed in a side surface of the sleeve and operatively engaged with a cylindrical surface of the shaft, an elongate slot formed in the sleeve parallel to a latitudinal axis formed in said sleeve hole in said holding base, and a limiting screw secured in the holding base and slidably engageable with the elongate slot for preventing an axial rotation of the sleeve about the latitudinal axis, and to ensure a snug engagement of the arcuate recess with the shaft.

8. A X-ray cassette holding means according to claim 7, wherein said thrusting member further includes an aperture formed between the arcuate recess and the shaft to render a stroke during fastening or unlocking of the adjusting means with or from the shaft and a packing member coated on a surface of the arcuate recess.

9. A X-ray cassette holding means according to claim 1, wherein said holding bracket includes: an elongate beam having a connector formed on a rear middle portion of the elongate beam to be connected with an adapter of the adjustable fastening means locked on the shaft of the supporting frame; and a pair of U-shaped portions disposed on opposite ends of the beam each formed with a knob hole to be engaged with a fastening knob, whereby upon insertion of a X-ray cassette into the two U-shaped portions and upon locking of the two fastening knobs in the two knob holes, the X-ray cassette is stably mounted on the holding bracket.

10. A X-ray cassette holding means according to claim 1, wherein said adjustable fastening means comprises: a holding base capable of sliding or rotating on the shaft; a driving bolt rotatably engageable with the holding base; a thrusting member rotatably coupled with the driving bolt and reciprocatively held in the holding base; and a follower block tangentially engageable with the thrusting member and reciprocatively moving in a block slot about a slot axis formed in the holding base; whereby upon rotating the driving bolt, the thrusting member is inwardly driven simultaneously to thrust the follower block and interfere in the surface of the shaft for firmly fastening the shaft with the holding base of the fastening means.

11. A X-ray cassette holding means according to claim 10, wherein said follower block includes: a follower wedge face formed on a first end portion of the follower block to be tangentially engageable with a driving wedge face of the thrusting member, a recess portion recessed in a second end portion of the follower block opposite to the follower wedge face in order to interfere in the shaft, a screw slot formed in the follower block parallel to the slot axis in the block slot in the holding base, and a stopping screw secured in the holding base and slidably engageable with the screw slot for preventing an axial rotation of the follower block about the slot axis.

12. A X-ray cassette holding means according to claim 1, wherein said adjustable fastening means includes: a collar capable of sliding or rotating on the shaft; a driving bolt rotatably engageable with the collar; a screw portion of the bolt operatively compressing the shaft; and an adapter formed on the collar for connecting the holding bracket; whereby upon rotating the knob of the driving bolt, the screw portion will compress the shaft for firmly fastening the shaft with the collar.

13. A X-ray cassette holding means according to claim 1, wherein said adjustable fastening means comprises: a clamp fastening the shaft; a driving bolt rotatably engageable with the clamp; a screw portion of the bolt coupling the clamp for operatively fastening the shaft; and an adapter formed on the clamp for connecting the holding bracket.

14. A X-ray cassette holding means according to claim 1, wherein said holding bracket includes: an elongate beam having a connector formed on a rear middle portion of the elongate beam to be connected with an adapter of the adjustable fastening means locked on the shaft of the supporting frame; and a pair of U-shaped portions disposed on opposite ends of the beam, whereby the X-ray cassette will be inserted into the two U-shaped portions on said beam.
